(19) United States
(12) Patent Application Publication
(10) Pub. No.: US 2015/0058031 A1
(43) Pub. Date: Feb. 26, 2015

(54) METHODS AND SYSTEMS FOR A MEDICAL CHECKLIST

(71) Applicants: Kyle Samani, Austin, TX (US); Patrick Kolencherry, Austin, TX (US)

(72) Inventors: Kyle Samani, Austin, TX (US); Patrick Kolencherry, Austin, TX (US)

(21) Appl. No.: 14/341,829

(22) Filed: Jul. 27, 2014

Related U.S. Application Data
(60) Provisional application No. 61/867,878, filed on Aug. 20, 2013.

(51) Int. Cl. G06Q 10/06; G06Q 50/22

(52) U.S. Cl. CPC G06Q 10/063114; G06Q 50/22
USPC 705/2

(57) ABSTRACT

Embodiments described herein disclose methods and systems to automatically present a checklist element to be completed by the medical practitioner. In embodiments, the medical practitioner may indicate that the presented checklist element is completed without using their hands. Therefore, the medical practitioner may maintain a sterile environment while completing checklist elements reducing the amount of time that the medical practitioner uses to complete a medical procedure.

### CROSS-REFERENCE TO RELATED APPLICATIONS

This application claims a benefit of priority under 35 U.S.C. §119 to Provisional Application No. 61/867,878 filed Aug. 20, 2013, which is fully incorporated herein by reference in its entirety.

### BACKGROUND INFORMATION

1. Field of the Disclosure

Examples of the present disclosure are related to techniques for presenting information associated with a medical checklist and completing the medical checklist. Specifically, embodiments may compare tokens associated with checklist elements with received data, which is obtained in a hands free manner, to determine if the checklist element is completed.

2. Background

A checklist is a type of informational job aid used to ensure consistency and completeness in carrying out a task. A checklist may lay out specific tasks to be completed. Conventionally, checklists are used in industries where failure to uniformly complete a task is unacceptable or may result in injury.

Checklists are often presented as lists with small checkboxes for checklist elements down a left hand side of the checklist. If a user completes a checklist element, the user may inscribe a small tick or checkmark in the associated checkbox. Thus, conventional checklists require a user to manually perform an action to inscribe the checkmark in the checkbox indicating that the user has performed the checklist element.

However, situations may arise, such as in a hospital, where a medical practitioner is in a sterile environment and is unable to use their hands to view the checklist, or use their hands to perform actions to indicate they have performed an action associated with the checklist. Further, the process of checking a checkbox indicating the medical practitioner has performed a checklist element takes time, and physically checking a checkbox may not ensure that the checklist element is completed.

Accordingly, needs exist for more efficient and effective methods and systems to determine if a checklist element of a checklist is completed.

### SUMMARY

Embodiments disclosed herein provide systems and methods to automatically present checklist elements to nurses, doctors, or other medical practitioners (referred to individually and collectively hereinafter as “medical practitioners”) before, during, and/or after a point of care for a patient, and determine if a checklist element is completed. The checklist elements may be form a checklist, debugging guide, protocols to follow, etc.

Embodiments may be configured to allow a medical practitioner to be automatically presented with a checklist element to be completed by the medical practitioner. The checklist element may be presented to the medical practitioner responsive to another checklist element being completed, a set of checklist elements being completed, or a checklist being initialized. In embodiments, the medical practitioner may indicate that the presented checklist element is completed without using their hands to perform actions to indicate that the medical practitioner has completed the checklist element. Therefore, the medical practitioner may maintain sterility while completing checklist elements, which may reduce the amount of time that the medical practitioner uses to complete a medical procedure.

In embodiments, a checklist may include a plurality of checklist elements, wherein each checklist element represents a medical procedure, task, action, operation, command, etc. to be completed by the medical practitioner. Additionally, checklists may include media to aid medical practitioners as they complete the checklist, such as sample pictures, videos, and audio.

In embodiments, a checklist element may include a name, a medical practitioner type corresponding to a type of medical practitioner to complete the checklist element, and tokens or keywords (referred to individually and collectively herein after as “tokens”). The tokens may be words, character strings, etc. associated with the checklist element. In embodiments, the tokens associated with a checklist element, and may be 1) a single keyword, such as “yes” or “no” or 2) a plurality or string of keywords.

In embodiments, after presenting the checklist element on a display to the medical practitioner, audio data may be received from the medical practitioner. Responsive to receiving the audio data from the medical practitioner, the audio data may be converted into text data. Then, the converted text data may be compared with the tokens.

In embodiments, to determine that a checklist element is completed, it may be desired and/or required to determine if the received audio includes each and every token associated with a checklist element, a percentage of the tokens associated with the checklist element, or a number of tokens associated with the checklist element above a token threshold.

In embodiments, the percentage of the tokens and/or the number for token threshold for the checklist element may be any desired number determined by empirical evidence, and may be the same and/or different for different checklist elements and/or medical practitioner types.

If the converted text data includes the tokens associated with the checklist element, then it may be determined that the checklist element is completed. By comparing the tokens to the converted text data to determine if a checklist element is completed, a more efficient and/or accurate system may be created rather than simply checking a checkbox for the checklist element. Additionally, this process may maintain a sterile environment.

In embodiments, responsive to a checklist element being completed, the next checklist element on the checklist may be presented to the associated medical practitioner.

In embodiments, different checklist elements may be configured to be presented on different client computing devices associated with different medical practitioners. The checklist elements may be configured to be presented to different medical practitioners based on the medical practitioner type assigned to the checklist element. Therefore, a checklist may include a plurality of checklist elements to be completed by different types of medical practitioners, wherein different checklist elements may be simultaneously presented to different medical practitioners.

In embodiments, the checklist elements may be configured to be sequentially presented to medical practitioners, such that responsive to determining that a first checklist element is completed by a first medical practitioner, a second checklist element may be presented to a second medical practitioner.

In embodiments, the checklist elements may be configured to be grouped, such that after a determination that all the checklist elements in a first group are completed by a first set of medical practitioners, checklist elements of a second group may be presented to the first set of medical practitioners.

In embodiments, the checklist elements may include a decision tree, such that the different checklist elements may be presented to a medical practitioner based on the received and converted text from the medical practitioner. For example, responsive to receiving converted text including a first grouping of tokens, a first checklist element may be presented to the medical practitioner, and if the converted text includes a second grouping of tokens then a second checklist element may be presented to the medical practitioner instead of the first checklist element. Therefore, the checklist elements may include different options, paths, processes the medical practitioner may complete while performing an operation.

In embodiments, the display of the client computing device associated with a medical practitioner may be positioned directly in front of the medical practitioner's face. Therefore, each medical practitioner may be authorized to use a single client computing device, which may be configured to only present information associated with the authorized medical practitioner on the display of the client computing device.

In embodiments, media such as pictures, videos and/or audio may be received from the client computing device while the medical practitioner is completing a checklist element. Responsive to receiving the media, the media may be stored in a database entry corresponding to the checklist element that is completed by the medical practitioner. In further embodiments, while a medical practitioner is completing the checklist element, media may be presented on a graphical user interface of the client computing device to assist the medical practitioner in completing the checklist element.

These, and other, aspects of the embodiments will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the embodiments, and the embodiments include all such substitutions, modifications, additions or rearrangements.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 depicts an embodiment of one topology for completing a medical checklist.

FIG. 2 illustrates one embodiment of a method for presenting relevant and timely medical information to a medical practitioner.

FIG. 3 illustrates one embodiment of a method for presenting relevant and timely medical information to a medical practitioner.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment”, “one example” or “an example” means that a particular feature, structure or characteristic described in connection with the embodiment or example is included in at least one embodiment of the present embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present embodiments may be implemented as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present embodiments may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present embodiments may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” and “in one embodiment.”

Embodiments disclosed herein provide systems and methods for medical practitioners to complete checklists before, during, and/or after a point of care for a patient. Embodiments may be configured to allow medical practitioners to be presented with a checklist element on a validated client computing device with a display that's fixed within the line of sight of the medical practitioner's vision, and be configured to allow the medical practitioner to complete the checklist without using their hands to interface with their client computing device. Therefore, medical practitioners may maintain sterility while more accurately and quickly completing the checklist, which may result in time and/or cost savings.

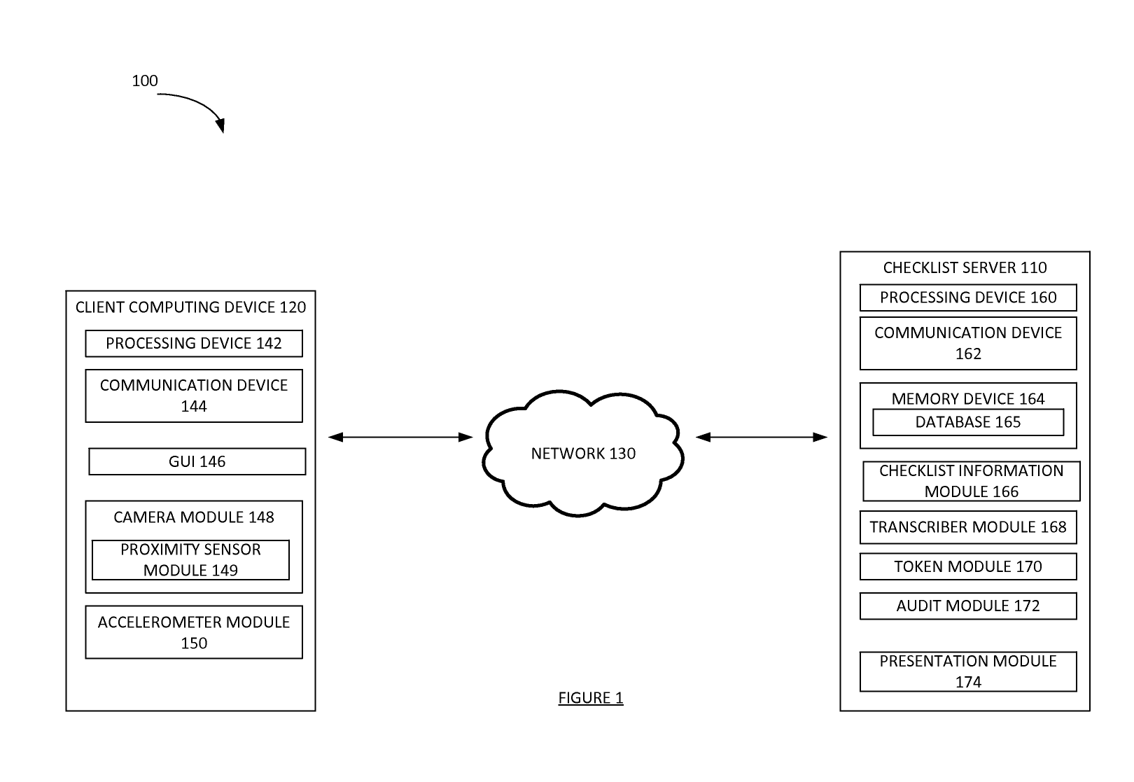

Turning now to FIG. 1, FIG. 1 depicts one topology 100 for completing a medical checklist. Topology 100 may include checklist server 110, at least one client computing device 120, and network 130. The elements depicted in topology 100 may be communicatively coupled to each other over network 130.

Network 130 may be a wired or wireless network such as the Internet, an intranet, a LAN, a WAN, a cellular network or another type of network. It should be understood that network 130 may be a combination of multiple different kinds of wired or wireless networks.

Checklist server 110 may be a computing device, such as a general hardware platform server configured to support mobile applications, software, and the like executed on client computing device 120. Checklist server 110 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Checklist server 110 may include any combination of one or more computer-usable or computer-readable media. For example, checklist server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

In embodiments, checklist server 110 may include a processing device 160, a communication device 162, a memory device 164, a checklist information module 166, a transcriber module 168, a token module 170, audit module 172, and presentation module 174.

Processing device 160 may include memory, e.g., read only memory (ROM) and random access memory (RAM), storing processor-executable instructions and one or more processors that execute the processor-executable instructions. In embodiments where processing device 160 includes two or more processors, the processors may operate in a parallel or distributed manner. Processing device 160 may execute an operating system of checklist server 110 or software associated with other elements of checklist server 110.

Communication device 162 may be a device that allows checklist server 110 to communicate with another device over network 130. Communication device 162 may include one or more wireless transceivers for performing wireless communication and/or one or more communication ports for performing wired communication. In embodiments, communication device 162 may be configured to receive: checklist information from client computing device 120 to generate a checklist, media from client computing device 120, and transmit information to be presented on client computing device 120.

Memory device 164 may be a device that stores data generated or received by checklist server 110. Memory device 164 may include, but is not limited to a hard disc drive, an optical disc drive, and/or a flash memory drive. In embodiments, memory device 164 may be configured to store information received from client computing device 120. The information stored within memory device 164 may be accessed by processing device 160, communication device 162, and/or modules 166, 168, 170, 172, 174.

In embodiments, memory device 164 may include a database 165 configured to receive and store checklist information. The checklist information may correspond to a checklist associated with a medical procedure. The checklist information stored within database 165 may include: a name of the checklist to identify the checklist, checklist elements which may be a task, procedure, action, etc. to be completed, a name of the checklist element, a medical practitioner type associated with a checklist element, a specific medical practitioner associated with a checklist element, a sequence identifier identifying the order that checklist elements should be completed, tokens associated with a checklist element, and/or a media identifier indicating if media should be received for the checklist element. In implementations, each checklist may have a unique global identifier utilized to identify a checklist within database 165.

Database 165 may also include an entry with a unique global identifier associated with a medical practitioner. The unique global identifier associated with the medical practitioner may correspond with a specific client computing device 120, information to validate the medical practitioner on client computing device 120, a login and password, biometric scanner, or any other known method to identify a medical practitioner, a type of medical practitioner, and/or a name of the medical practitioner.

Checklist module 166 may be configured to receive checklist information to generate a checklist. Checklist module 166 may be configured to receive checklist information from client computing device 120 and/or an interface of checklist server 110. In implementations, checklist module 166 may be configured to dynamically receive checklist information from a medical practitioner, such that the medical practitioner may generate a checklist for a medical procedure. In other implementations, checklist module 166 may be configured to receive checklist information from a plurality of data sources over network 130 to generate checklists. Checklist module 166 may be configured to receive commands from client computing device 120 to change and/or modify checklist information received from data sources.

To generate a checklist, checklist module 166 may receive a name of the checklist, checklist elements, medical practitioner type(s) associated with a checklist, medical practitioner type(s) associated with a checklist element, identifiers of specific medical practitioners associated with a checklist element, a sequence identifier identifying the order that checklist elements should be completed, tokens associated with a checklist element, and/or a media identifier indicating if media should be received for the checklist element. In embodiments, the name of the checklist may be configured to identify the checklist within database 165.

Each checklist element may be associated with a different action and/or medical procedure to be performed by a medical practitioner. For example, a checklist element may be associated with an action to sanitize a scalpel before performing surgery or any other medical procedure. Furthermore, each checklist element may have corresponding tokens that are associated with the completion of a task.

The medical practitioner type(s) associated with the checklist may be configured to determine each medical practitioner type and a quantity of each medical practitioner type that may be necessary, desired, and/or required to perform each checklist element for the checklist. In embodiments, before starting a checklist it may be desired that certain types of medical practitioners and/or specific medical practitioners are assigned to the checklist or checklist elements, are logged into checklist server 110, are at a specific location (e.g. a room within a hospital), and/or within close proximity to one another. Accordingly, a medical checklist may be initiated responsive to a certain types of medical practitioners being located at a location simultaneously. The medical practitioner type associated with the checklist element may be an identifier signaling what type of medical practitioner is desired and/or required to perform the actions corresponding with the checklist element. The medical practitioner type may also be configured to determine what medical practitioners should receive information associated with checklist element to be performed by the medical practitioner. Therefore, the medical practitioners may only receive information associated with checklist elements that they should perform, and not information associated with each task for a medical procedure. In embodiments, the medical practitioner type of a medical practitioner may be determined based on the medical practitioner type information associated with the medical practitioner stored within database 165. In further implementations, a specific medical practitioner may be assigned to a checklist element via an identifier of the medical practitioner and/or the checklist stored within database 165, such as the medical practitioner's name, login-information, employee number, medical license number, etc. Therefore, it may be required for the specific medical practitioner to complete a checklist element.

The sequence identifier may be configured to identify the order that checklist elements should be completed. For example, the sequence identifier may be a numerical identifier, identifying the first checklist element to be completed. Responsive to determining that the first checklist element is completed, information associated with the second checklist element may be transmitted to a medical practitioner corresponding to the second checklist element. In embodiments, the sequence identifier may also be a grouping and/or subgrouping of checklist elements, such that a first grouping of checklist elements may be desired and/or required to be performed before transmitting checklist elements of a second grouping of checklist elements. In embodiments, the sequence identifier may be a decision tree; such that responsive to determining what actions associated with a checklist element are completed, different checklist elements may be presented on client computing device 120. For example, a checklist element of a decision tree may be associated with identifying if a patient's age is above 65 years old, if it is determined that the patient's age is older than 65 then a second checklist element may be presented to a medical practitioner, while if it is determined that the patient's age is younger than 65 then a third checklist element may be presented to the medical practitioner.

The tokens associated with the checklist element may be keywords and/or character strings configured to determine if the checklist element is completed. The tokens may be received from client computing device 120 and/or an interface of checklist server 110. Responsive to receiving audio data including at least one, a certain number, a certain percentage, and/or all of the tokens associated with the checklist element, it may be determined that the medical practitioner performed the corresponding medical task associated with the checklist element. In embodiments, the tokens associated with a checklist element may be a single keyword, such as “yes” or “no” or a string of keywords.

The media identifier associated with the checklist element may be an indicator configured to determine if media should be received for the checklist element. If the media identifier indicates that media should be received for the checklist element, then to complete a checklist element it may be desired and/or required to receive media associated when the medical practitioner has performed the corresponding medial task associated with the checklist element. For example, it may be desired and/or required to receive an image from client computing device 120 associated with an incision before determining that a checklist element is completed. In embodiments, the media identifier may be associated with a type of media such as audio, video, pictorial, etc., and may also require or desire that the media to be obtained in a certain way. For example, the media identifier may require that the media is obtained responsive to the medical practitioner winking one of the medical practitioner's eyes.

Transcriber module 168 may be a natural language processor configured to receive audio data from client computing device 120, and convert the audio data into text based data. In embodiments, transcriber module 168 may be configured to filter stop words within the converted text based data. Transcriber module 168 may be configured to filter stop words by a parsing a natural language processing system prior to and/or after converting the audio data into text data. Stop words may be defined in a possibly non-definite list. Any word of a natural language may be chosen as a stop word. Examples of stop words may include “the,” “is,” “at,” “and,” “which,” “that,” “to,” “but,” and other similar words. Other known natural language processing systems may, depending on their informative content, filter stop words such as want, may, would, etc. from converted text data.

Token module 170 may be configured to compare the tokens associated with a checklist element with the filtered text data. Responsive to token module 170 determining that the filtered text data includes the tokens associated with the checklist element, token module 170 may determine that a medical practitioner has completed the checklist element. If token module 170 determines that the medical practitioner has completed a checklist element, token module 170 may transmit data to be stored within database 165 indicating that the checklist element is completed. The transmitted data may include a timestamp indicating when the checklist element is presented to the medical practitioner, a timestamp indicating when the checklist element is completed, the type of medical practitioner that completed the checklist element, an identifier of the medical practitioner that completed the checklist element, and/or data indicating that the checklist element is completed. Responsive to token module 170 determining that the filtered text data does not include the tokens associated with the checklist element, token module 170 may determine that the medical practitioner has not completed the checklist element. If token module 170 determines that the medical practitioner has not completed the checklist element, token module 170 may transmit data configured to be presented on client computing device 120, wherein the transmitted data may indicate that the medical practitioner has not supplied audio data associated with a completed checklist element.

In embodiments, token module 170 may determine that the medical practitioner has completed the checklist element if the filtered text data includes at least one of the tokens associated with the checklist element, each of the tokens associated with the checklist element, a percentage of the tokens associated with the checklist element, and/or a number of tokens above a token threshold. In embodiments, the percentage of the tokens and/or the token threshold may be any desired number determined by empirical evidence, and may be the same and/or different for different checklist elements and/or medical practitioner type.

Audit module 172 may be configured to receive and store media data before, during, and/or after a checklist is being completed. The received media data may be audio based data, image based data, or a combination, which may be received from client computing device 120. Responsive to receiving the media data, audit module 172 may store the media data in an entry within database 165 corresponding to a checklist, a checklist element, medical practitioner's identifier, medical practitioner type, and/or client computing device 120. The media may be stored along with a timestamp that the media was obtained, a medical practitioner type associated with the medical practitioner operating client computing device 120, and/or an identifier of the medical practitioner operating client computing device 120. The stored media may be configured to be presented on a graphical user interface of a computing device, and may be utilized to review a medical practitioner's performance, determine the amount of time required for a medical practitioner to perform a checklist element, determine if the medical practitioner is performing checklist elements as desired, etc.

Presentation module 172 may be configured to transmit information associated with a medical checklist to be presented on a graphical user interface of client computing device 120. In embodiments, the transmitted information may indicate that the medical practitioner should perform an action associated with a checklist element, transmit media indicating that the medical practitioner has completed the action associated with the checklist element, and/or transmit data indicating that the medical practitioner has completed a checklist element and/or the checklist is completed.

Client computing device 120 may be a wearable computer, personal data assistant, Google Glass®, or any other type of mobile device with a hardware processor that is configured to process instructions and connect to one or more portions of network 130. Client computing device 120 may include processing device 142, communication device 144, and graphical user interface (GUI) 146, and/or camera module 148.

Processing device 142 may include memory, e.g., read only memory (ROM) and random access memory (RAM), storing processor-executable instructions and one or more processors that execute the processor-executable instructions. In embodiments where processing device 142 includes two or more processors, the processors may operate in a parallel or distributed manner. Processing device 142 may execute an operating system of client computing device or software associated with other elements of client computing device.

Communication device 144 may be a device that allows client computing device 140 to communicate with another device over network 130. Communication device 144 may include one or more wireless transceivers for performing wireless communication and/or one or more communication ports for performing wired communication. In embodiments, communication device 144 may be configured to transmit and/or receive medical information associated with a checklist to or from checklist server 110.

GUI 146 may be a device that allows a medical practitioner to interact with client computing device 140, without the medical practitioner using their hands to interface with GUI 146. While one GUI is shown, the term “graphical user interface” may include, but is not limited to being, a touch screen, a physical keyboard, a mouse, a heads up display, glasses, some form of eye ware augmented reality to the user, a microphone, and/or a speaker. GUI 146 may be configured to receive inputs, including audio and/or visual data, associated with a checklist. The received inputs may be transmitted to checklist server 110 over network 130. In embodiments, GUI 146 may be configured to automatically present checklist information on GUI 146 without receiving inputs or commands. GUI 146 may be configured to receive audio data associated with a checklist from a medical provider via a microphone, and GUI 146 may transmit the audio data to checklist server 110. In further embodiments, GUI 146 may be configured to convert the audio input into a text based input utilizing voice-to-text processing systems. In embodiments, GUI 146 may be configured to present information on a display in front of a single medical practitioner. Therefore, the medical practitioner may only be presented with information that is relevant and/or associated with the medical practitioner and checklist elements that the medical practitioner should complete.

Camera module 148 may be a hardware device or any other device configured to record images from a first person point of view of the medical practitioner. The recorded images may be stored within memory device 164 or transmitted to checklist server 110 over network 130. Camera module 148 may be a device that can record still images or videos via voice commands, responsive to a wink of a medical practitioner's eyelid, and/or any other input that does not require the medical practitioner to use their hands. In embodiments, camera module 148 may include proximity sensor module 149.

Proximity sensor module 149 may be configured to determine if the medical practitioner has winked one of their eyes, and to differentiate between blinks and winks. If the medical practitioner has winked one of their eyes, proximity sensor module 149 may be configured to communicate data to camera module 148 indicating that camera module 148 should record images from the first person point of view of the medical practitioner. Therefore, proximity module 149 may enable the medical practitioner operating client computing device 120 to record media without receiving commands from the medical practitioner's hands, while also allowing the medical practitioner to blink while performing a checklist element because proximity sensor module 149 is configured to differentiate between blinks and winks.

Accelerometer module 150 may be a hardware processing device configured the measure proper acceleration of the medical practitioner's head to initiate, turn on, etc. client computing device 120 or a checklist. In embodiments, responsive to accelerometer module 150 determining that the medical practitioner's head is accelerating at a rate greater than an acceleration threshold, then client computing device 120 and/or a checklist may be turned on, initiated, etc. In embodiments, the acceleration threshold may be determined by empirical data associated with head movements. For example, in one embodiment, the acceleration threshold may be set at a rate lower than the rate at which the medical practitioner may node and/or shake their head. Therefore, the medical practitioner may initiate a checklist by nodding and/or shaking their head. As such, client computing device 120 and the checklist may be initiated based on the medical practitioner's head movements and without receiving inputs from the medical practitioner's hands.

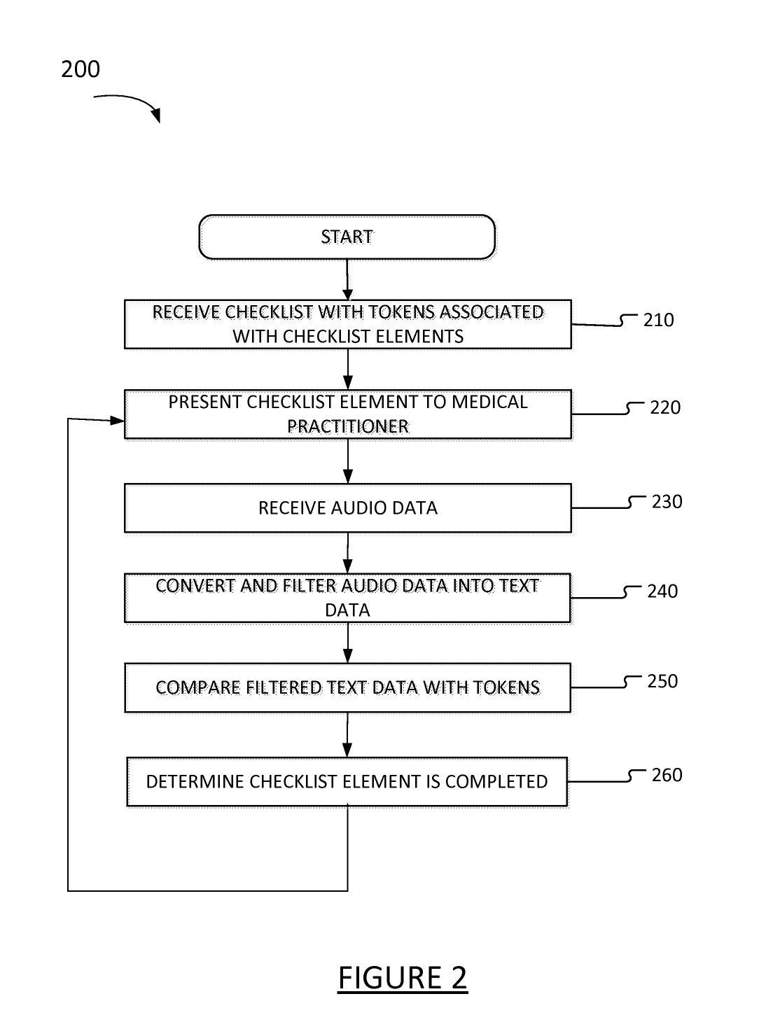

FIG. 2 illustrates a method 200 for presenting relevant and timely medical information to a medical practitioner. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 210, a checklist with at least one checklist element including tokens may be received. The tokens associated with the checklist element may be keywords and/or character strings configured to determine if the checklist element is completed. The tokens may be configured to validate that the medical practitioner has transmitted audio data indicating that a checklist element is completed. Operation 210 may be performed by a checklist module that is the same as or similar to checklist module 166, in accordance with one or more implementations.

At operation 220, a checklist element may be presented to a medical practitioner. The checklist element presented to the medical practitioner may indicate that the medical practitioner should perform a medical task, and transmit audio data and/or media data indicating that the medical practitioner has performed the checklist element. Operation 220 may be performed by a presentation module that is the same as or similar to presentation module 174, in accordance with one or more implementations.

At operation 230, audio data may be received being provided by the medical practitioner performing the medical task. The audio data may be provided by the medical practitioner in a hands free manner responsive to the checklist element being presented to the medical practitioner and/or the medical practitioner performing the corresponding medical talk. In embodiments, the audio data may be received while the checklist element is presented on a graphical user interface of a client computing device. Operation 230 may be performed by a token module that is the same as or similar to token module 170, in accordance with one or more implementations.

At operation 240, the received audio data may be converted into text based data. In embodiments, stop words may be filtered from the converted text based data. The filter stop words may be defined in a possibly non-definite list. Any word of a natural language may be chosen as a stop word. Operation 240 may be performed by a transcriber module that is the same as or similar to transcriber module 168, in accordance with one or more implementations.

At operation 250, the tokens associated with a checklist element may be compared with the filtered text data. If it is determined that the filtered text data includes the tokens associated with the checklist element, then it may be determined that a medical practitioner has completed the checklist element. Responsive to determining that the filtered text data does not include the tokens associated with the checklist element, then it may be determined that the medical practitioner has not completed the checklist element. Operation 250 may be performed by a token module that is the same as or similar to token module 170, in accordance with one or more implementations.

At operation 260, it may be determined that the medical practitioner completed a checklist element based on determining that the filtered text data includes at least one tokens associated with the checklist element. If it is determined that the checklist element is completed, the next checklist element for the checklist may be presented to the medical practitioner. If it is determined that the medical practitioner has not completed a checklist element after comparing the tokens and filtered text data, a reminder to complete the checklist element may be presented to the medical practitioner. In further embodiments, the next checklist element presented to the medical practitioner may be based on a decision tree associated with the checklist, where different checklist elements may be presented to the medical practitioner based on the received and converted text from the medical practitioner to complete the checklist element. For example, the checklist element may be completed at operation 260 responsive to receiving converted text including a first grouping of tokens, and a second checklist element may be presented to the medical practitioner based on the converted text including the first grouping of tokens. Whereas, the checklist element may be completed at operation 260 responsive to the converted text including a second grouping of tokens, and a third checklist element may be presented to the medical practitioner based on the converted text including the second grouping of tokens. Operation 260 may be performed by a token module that is the same as or similar to token module 170, in accordance with one or more implementations.

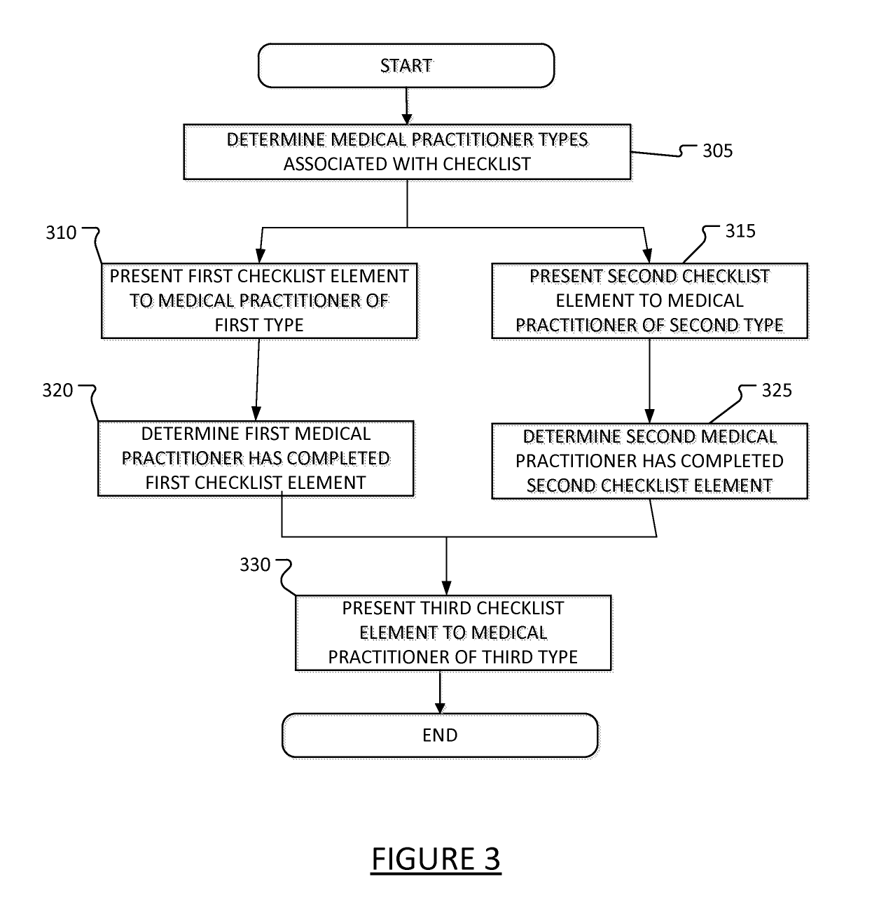

FIG. 3 illustrates a method 300 for presenting relevant and timely medical information to a medical practitioner. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At operation 305, medical practitioners associated with a checklist may be determined. The medical practitioners associated with the medical health record may be based on the types of medical practitioners required to perform different medical tasks associated with the checklist. Furthermore, at operation 305 it may be determined that the medical practitioners desired to complete a medical checklist, in type and quantity, are located in close proximity to one another. Operation 305 may be performed by a checklist module that is the same as or similar to checklist module 166, in accordance with one or more implementations.

At operation 310, first checklist information associated with a first checklist element may be presented to a first medical practitioner. The first checklist information associated with the first checklist element may be presented to the first medical practitioner based on the first medical practitioner's type. Therefore, the first medical practitioner may only be presented with checklist information associated with medical tasks that the first medical practitioner should complete. Operation 310 may be performed by a checklist module that is the same as or similar to checklist module 166, in accordance with one or more implementations.

At operation 315, which may be completed simultaneously as operation 310, second checklist information associated with a second checklist element may be presented to a second medical practitioner. The second checklist information associated with the second checklist element may be presented to the second medical practitioner based on the first medical practitioner's type. Therefore, the second medical practitioner may only be presented with checklist information associated with medical tasks that the second medical practitioner should complete. Operation 315 may be performed by a checklist module that is the same as or similar to checklist module 166, in accordance with one or more implementations.

At operation 320, it may be determined that the first medical practitioner has completed the first checklist element. It may be determined that the first medical practitioner completed the first checklist element responsive to receiving audio that that corresponds to at least one tokens associated with the checklist element. Operation 320 may be performed by a token module that is the same as or similar to token module 170, in accordance with one or more implementations.

At operation 325, it may be determined that the second medical practitioner has completed the second checklist element. It may be determined that the second medical practitioner completed the second checklist element responsive to receiving audio that that corresponds to at least one tokens associated with the checklist element. Operation 325 may be performed by a token module that is the same as or similar to token module 170, in accordance with one or more implementations.

At operation 330, responsive to at least one (or both) of operation 320 or 325 being completed, a third checklist element may be presented to a third medical practitioner. In embodiments, the third medical practitioner may be a third type of medical practitioner. Accordingly, different checklist elements may be presented to different medical practitioners based on who should complete the medical task. Operation 330 may be performed by a checklist module that is the same as or similar to checklist module 166, in accordance with one or more implementations.

Although the present technology is described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for completing a medical checklist, the system comprising:
a checklist information module configured to receive a first checklist element over a network, the first checklist element being associated with a medical task and includes a first medical practitioner type and at least one token;
a transcriber module configured to receive audio data from a first medical practitioner, and convert the audio data into text data; and
a token module configured to compare the at least one token with text data, the token module being configured to determine that the medical task associated the first checklist element is completed responsive to the text data including the at least one token.

2. The system of claim 1, wherein the at least one token includes a plurality of keywords.

3. The system of claim 2, wherein the token module is configured determine that the first checklist element is complete responsive to the text data including each of the plurality of keywords.

4. The system of claim 1, wherein the checklist information module is configured to receive a checklist, the checklist including the first checklist element and a second checklist element.

5. The system of claim 4, wherein the first checklist element is configured to be presented to the first medical practitioner having the first medical practitioner type, and the second checklist element is configured to be presented to the second medical practitioner having the second medical practitioner type.

6. The system of claim 4, including a presentation module being configured to present information associated with the second checklist element after the token module determines that the first checklist element is completed.

7. The system of claim 4, wherein the first checklist element and the second checklist element have different tokens.

8. The system of claim 1, wherein the audio data is configured to be received from the first medical practitioner while the first medical practitioner is completing a task associated with the first checklist element.

9. The system of claim 1, wherein the token module is configured to determine that the first medical practitioner did not complete the medical task associated with the first checklist element responsive to the text data not including the at least one token.

10. The system of claim 1, further comprising:
a camera module being configured to record a first image while the first medical practitioner completes the medical task associated with the first checklist element, wherein the first checklist element includes a media token; and
the token module is configured to determine that the medical task associated with the first checklist element is completed responsive to receiving the first image.

11. A method for completing a medical checklist, the method comprising:
receiving a first checklist element over a network, the first checklist element being associated with a medical task and includes a first medical practitioner type and at least one token;
receiving audio data from a first medical practitioner;
converting the audio data into text data;
comparing the text data with the at least one token;
determining that the medical task associated with the first checklist element is completed responsive to the text data including the at least one token.

12. The method of claim 11, wherein the at least one token includes a plurality of keywords.

13. The method of claim 12, further comprising:
determining that the first checklist element is completed responsive to the text data including each of the plurality of keywords.

14. The method of claim 11, further comprising:
receiving a checklist, the checklist including the first checklist element and a second checklist element.

15. The method of claim 14, further comprising:
presenting the first checklist element to the first medical practitioner having the first medical practitioner type; and
presenting the second checklist element to the second medical practitioner having the second medical practitioner type.

16. The method of claim 14, further comprising:
presenting information associated with the second checklist element after determining that the first checklist element is completed.

17. The method of claim 14, wherein the first checklist element and the second checklist element have different tokens.

18. The method of claim 11, wherein the audio data is configured to be received from the first medical practitioner while the first medical practitioner is completing a task associated with the first checklist element.

19. The method of claim 11, further comprising:
determining that the first medical practitioner did not complete the medical task associated with the first checklist element responsive to the text data not including the at least one token.

20. The method of claim 11, further comprising:
receiving a first image from a camera while the first medical practitioner completes the medical task associated with the first checklist element, wherein the first checklist element includes a media token; and
determining that the medical task associated with the first checklist element is completed responsive to receiving the first image.
